(19) United States
(12) Patent Application Publication
(10) Pub. No.: US 2006/0113944 A1
(43) Pub. Date: Jun. 1, 2006

(54) Screening device with motor drive and use hereof

(76) Inventors: Per Solsø Hindhede, Skjern (DK); Verner Beck Jacobsen, Videbaek (DK)

Correspondence Address: DORITY & MANNING, P.A., POST OFFICE BOX 1449, GREENVILLE, SC, 29602-1449, US

(21) Appl. No.: 10/515,890

(22) PCT Filed: Jun. 4, 2003
(86) PCT No.: PCT/DK03/00366

§ 371 Date: May 19, 2005

(30) Foreign Application Priority Data
Jun. 14, 2002 (DK) PA 2002 00910

(51) Int. Cl. H02P 7/00

(52) U.S. Cl. 318/466

(57) ABSTRACT

Screening device for screening opening in building, window, door or the like, said screening device comprising a screening element (11) which in an inactive position is rolled up, folded together, gathered together or the like at a first position. The screening element is connected at a free end to a movable part such as a bottom bar (10). This bottom bar can be moved in relation to said first position by means of one or more endless driving cords or the like which extend in one or more closed circuits and which can be driven by means of least one driving motor. The movable part (10) is mechanically connected to said at least one driving cord by means of friction-producing means which are of such a kind that the friction can be overcome by a manual operation.

### FIELD OF THE INVENTION

The invention relates to a screening device for screening of an opening in a building, a window, a door or the like, the screening device including a screening material which in an inactive condition is rolled up, folded together, pleated or the like in a first position, and which at a free end is connected to a movable part such as a bottom bar which can be moved in relation to the first position via at least one endless driving cord or the like which can be driven via at least one driving motor.

The invention also relates to the uses of such a screening device.

### BACKGROUND OF THE INVENTION

Screening devices, among other things for the screening against light, heat, noise etc., from openings in buildings, windows, glazed doors or the like, exist in embodiments such as manually operated and as arrangements which, e.g., are driven electrically by e.g. an electric motor. The first-mentioned exists in versions, which can be mounted immediately in building openings, window, doors and so on, also including mounting by non-professional persons. Such a manual arrangement is, e.g., known from WO 98/32944, which describes an arrangement with parallel guidance of a bottom bar, where two guide cords are mounted in a window in such a manner that these guide cords cross through the bottom bar.

The later arrangements, i.e. motor-driven arrangements, are for the most part of a more complex character and their installation requires the services of a professional. This is known, e.g., from WO 00/05478, where an electric motor and a battery are built into a bottom bar of a screening device, which can be controlled by a remote control. The screening device is guided in a parallel movement using two cords or wires which are led from top to bottom of a window in such a manner that they are led through the bottom bar, where they cross each other, and where via driving rollers or the like, the electric motor can draw the bottom bar up and down by the cords. With this cord arrangement, movement of the bottom bar is effected in a parallel manner.

In as much as the electrical drive is built into the bottom bar, which is moved up and down, out of regard for a practical energy supply this can involve a battery supply, which is placed in the bottom bar but, however, other forms of energy supply for the electrical drive can also be envisaged, e.g. via slide contacts or similar means. Under all circumstances, the construction of the bottom bar etc. is complicated by such a building-in of the electrical drive into the bottom bar, as well as the weight of the bottom bar will be increased due to the elements which are built into it.

With such screening devices and with driving arrangements in general which can be driven by some form of automatics, e.g. by an electrical drive or driven by other means and which can possibly be operated by a remote control, it will often be problematic to be able to operate these in a purely manual manner in the event that this should be desirable. It can thus be the case that, e.g., should attempts be made to push a roller blind upwards, it will at the same time be required to drive the driving mechanism with which the roller blind is normally driven, e.g. an electric motor, a transmission mechanism etc., which in practice can be difficult, inexpedient and in certain cases impossible.

Furthermore, there can be cases where such driving mechanisms are configured as self-locking mechanisms, e.g. to prevent a driving arrangement for a roller blind in rolling downwards under influence of the force of gravity, or upwards under the influence of a spring force, whereby the roller blind is rolled upwards when this is permitted by the driving arrangement. In these cases it will not be possible to push the adjusting drive in a purely manual manner.

In the above-mentioned WO 00/05478 there is thus described an embodiment in which use is made of a self-locking mechanism in connection with the driving arrangement, and the publication also discloses that it is possible to effect a manual operation by deactivation of a coupling. However, for several reasons, such a decoupling mechanism can be inexpedient in that it can serve to complicate the construction and make it more expensive, and it can also complicate the operation.

A further example of an electrically-driven device is described in U.S. Pat. No. 5,170,108. This publication concerns a screening device with a single electric motor which, via an endless driving cord and a number of pulleys or the like, can draw a bottom bar up or down in a window. The driving cord is firmly connected to the bottom bar and with this arrangement there is no immediate possibility of carrying out a manual adjustment of the position of the bottom bar.

### BRIEF SUMMARY OF THE INVENTION

The invention provides in general a screening device, which can be operated via a driving arrangement.

In one aspect of the invention, a screening device is provided that effects a manual adjustment of a position, e.g. in cases where a remote control is not immediately at hand or where a source of energy, e.g. a battery supply, can not supply current for the operation.

In another aspect of the invention, a screening device can be operated manually without the necessity of having to activate a special coupling or the like, and thus such a screening device requires a relatively uncomplicated coupling arrangement, which does not need to be deactivated. Further, the device is relatively less expensive.

In a further aspect of the invention, a screening device is provided to ensure a faultless de-coupling of the device in end positions, i.e. the bottom and top position.

More particularly, the invention in one aspect concerns a screening device for the screening of an opening in a building, a window, a door or the like, the screening device including a screening material which in an inactive position is rolled up, folded together, pleated or the like at a first position, and which at a free end is connected to a movable part such as a bottom bar which can be moved in relation to the first position via at least one endless driving cord or the like, which can be driven via at least one electric driving motor, the movable part being connected mechanically to the driving cord by a friction-producing arrangement(s).

In a relatively simple manner and by relatively simple means, the screening device can be operated via built-in driving means, e.g. an electric motor, while at the same time that the possibility is provided of carrying out a manual adjustment. With the normally occurring motor operation, the movable part, i.e. e.g. the bottom bar, will be moved in relation to the opening in the building via the driving cord, in that this will transfer traction force to the bottom bar via the friction-producing arrangement. With a manual operation, the bottom bar can be moved by it being pushed or drawn in the opening of the building, in that the driving cord will thereby slide e.g. via, over, through or past the friction-producing arrangement.

The friction-producing arrangement can be configured in a wide variety of ways, such as will also be described in the following. Generally, the arrangement will be configured such that with normal operation there can be transferred a force which is sufficiently great to be able to move the movable element, but such that the static friction produced will not be greater than it can be overcome when it is desired to effect a manual operation, such as explained above. The friction-producing arrangements will thus distinguish themselves by exercising a friction, which will lie between a required minimum value for the specific system and a predetermined maximum value for the specific system. It will be apparent to the skilled artisan that there will be tolerances associated with both values.

It will be understood that in this connection the designation “driving cord” shall be taken to mean any form of driving means which can transfer traction in the longitudinal direction and which is sufficiently flexible in the transverse direction to be able to pass over a driving roller, pulleys, wheels, pivots etc. In connection with the invention, use can thus be made, e.g., of driving belts, wires, cables, chains or chain-like means etc.

According to an expedient embodiment, the friction-producing arrangement can comprise at least one edge over which the driving cord is led. In a relatively simple manner, there is hereby achieved a suitable friction between the driving cord, which under normal use draws the bottom bar up or down, so that this friction is sufficiently great to ensure the movement of the bottom bar by this operation. At the same time it can be ensured that the friction is not greater than upon manual operation, e.g. a pull or a push on the bottom bar, it will be possible for the driving cord to slide over the edge, so that the user can effect a manual operation if this is desirable or necessary. A suitable friction can also be brought about by arranging the driving cord in such a manner that an angle is formed between the lead-in of the driving cord towards the edge area and the run-off of the driving cord from the edge area. It will be obvious that this angle can be adapted to suit the specific construction.

According to a further expedient embodiment, the edge can be rounded off in order to achieve a contact distance of a predetermined length.

In an expedient manner, the necessary and sufficient frictional force can hereby be produced by a suitable configuration of the edge, so that in interaction with the passing of the driving cord, and including the angle at which the cord extends during passage of the edge, a suitable length can be achieved over which the driving cord and the edge material are pressed against each other and can influence each other in achieving the necessary friction.

As disclosed, the screening device can be configured in such a manner that the friction-producing arrangement includes at least two edges over which the driving cord is led.

In a simple manner it is hereby achieved that the necessary friction between driving cord and the movable part, e.g. the bottom bar, can be suitably distributed over several elements, so that a greater degree of freedom is achieved in the dimensioning of the particular friction-producing elements individually and the bottom bar as a whole.

In accordance with another aspect of the invention, the friction-producing arrangement can comprise guiding means in the form of grooves or the like.

There is hereby achieved a further expedient manner in which the necessary friction can be produced, which can be implemented in connection with or instead of other embodiments of the friction-producing arrangement. By allowing the driving cord to pass a groove or the like, an influence will arise over a greater part of the driving cord's periphery—or over a greater part of the periphery of the relevant driving means—so that with this embodiment the friction between the driving cord and bottom bar is increased.

According to a further aspect of the invention, the screening device can be configured in such a manner that the friction-producing arrangements comprise clamping means, which can possibly be spring-loaded and/or adjustable.

With this embodiment, where direct use can be made of a form of clamping around the driving cord or a corresponding driving medium, a higher friction can be achieved relatively simply. When use is made of an adjustable clamping, possibly with the use of a spring force or the like, it can also be achieved that the degree of friction between driving cord and bottom bar can be adjusted to a suitable value, e.g. depending on the type of cord, its surface characteristics etc.

With a particularly expedient embodiment of the invention, the device can comprise two driving cords, which are each led in their individual closed circuits via pulleys or similar means, and where for each driving cord there are arranged friction-producing arrangements in, on or at the movable part, e.g. the bottom bar, in as much as the two driving cords cross each other in, at or in the vicinity of the movable part, e.g. the bottom bar.

The invention can hereby be used in connection with a device comprising a parallel guide of the type, which comprises two driving cords in each, their closed circuits, and where these two driving cords are driven in each their direction. It will thus also be achieved that the movement of movable part, e.g. the bottom bar, will be guided in a parallel manner, also during manual adjustment.

With a further alternative embodiment, the device can include at least one driving cord, which is guided in a closed circuit via pulleys or similar means, and where for the closed circuit there are arranged friction-producing arrangements in, on or at each end of the movable part, e.g. the bottom bar.

There is hereby achieved a particularly simple embodiment of the invention, where the at least one driving cord does not need to pass the movable part, e.g. the bottom bar, but can pass or be connected to its ends, in as much as the respective courses of the driving cord extend at each side of the screening device. However, with this embodiment the at least one driving cord can also be arranged in such a manner that it crosses itself in connection with the passage of the bottom bar, in that the driving cord extends via or at the bottom bar from its one end to the other and vice versa.

According to yet another aspect of the invention, it can be expedient for the device to comprise at least one driving motor which, possibly via a transmission mechanism and one or more driving rollers or the like, drives the at least one driving cord, where the device comprises a control circuit for stopping the device at predetermined positions, such as an upper and a lower position.

It is hereby achieved that the device can automatically stop operating when it reaches to one of the positions without it being necessary to mount sensors, feelers or the like to detect that such a position has been reached.

With a particularly expedient embodiment, the device can be configured in such a way that at one or more of the predetermined positions, the movable part, e.g. the bottom bar, is brought into contact with guide means, e.g. pulleys or the like, for the at least one driving cord.

It is hereby achieved that in connection with the invention an automatic stopping of the device will safely be able to take place at, e.g., an end-stop, also when for use at such stopping of the device a detection of motor current or corresponding parameters is employed. In that precisely such an embodiment of the invention has been implemented such that a driving cord will be able to be moved over the friction-producing arrangement, e.g. by manual operation, this will also be able to take place when e.g. the bottom bar has reached down to the bottom of a window or the like. In this case the change in motor current will possible be too small to enable an automatic stopping to be initiated and in the given case not with certainty. This disadvantage is obviated with the embodiment of the invention in that in this or the positions it will happen that the movable part, e.g. the bottom bar, will come into physical contact with one of the means, e.g. a pulley or the like, over which a driving cord extends, so that this pulley or the like is wholly or partly braked. A braking force will hereby be transferred to the driving cord, so that a distinct change in the operational parameters of the driving motor can be detected, e.g. a change in the motor current, whereby a stopping of the driving mechanism can be initiated.

In another aspect of the invention, the movable part, e.g. the bottom bar, can have means for effecting a braking of the guiding means, whereby a suitable increase in the motor load is achieved and herewith a reliable activation of the stopping automatics. The means can comprise friction-promoting means of various kinds, means for mechanical interaction and so on, as will be obvious to the expert.

By yet a further expedient embodiment, the movable part, e.g. the bottom bar, can have a recess for reception of the guiding means, e.g. a pulley. Several advantages will be achieved hereby in that the top or bottom of the bottom bar will be able to come closer to e.g. the top or bottom of an opening in a building before contact is established to e.g. a pulley, and in as much as the recess will more easily be able to be configured to achieve a suitable braking effect on a pulley.

The concrete configuration of the form of contact between e.g. the bottom bar and a pulley can be effected in many different ways, such as it is exemplified in the following detailed description, and these configurations can similarly be implemented with the use of different materials etc.

By way of further example, the invention also relates to the use of the screening device as described above in connection with a light-screening means, possibly a blackout curtain, and/or a screening means for screening against outer influences such as, e.g., draught, insects etc.

Finally, the invention relates to the use of the screening device as described above in connection with a screening material in the form of a roller blind, a foldable curtain, a Venetian blind or a shutter arrangement.

### BRIEF DESCRIPTION OF THE DRAWINGS

In the following, the invention will be described in more detail with reference to the drawings, in which:

FIG. 1 is an interior view of a window with a screening device according to an embodiment of the invention,

FIG. 2 shows a modified embodiment of the screening device shown in FIG. 1,

FIG. 3 is a schematic view of a second modified embodiment of the screening device according to the invention,

FIG. 4 shows a further embodiment of the invention,

FIG. 5 shows a further embodiment of the invention in which a single, closed driving loop is used,

FIG. 6 shows a modification of the embodiment shown in FIG. 5,

FIG. 7 shows an enlarged illustration of a detail section of an end of a bottom bar in the vicinity of the bottom of a window frame in another embodiment of the invention, and

FIG. 8 shows the detail section shown in FIG. 7, seen from the end of the bottom bar.

### DETAILED DESCRIPTION OF THE DRAWINGS

Detailed reference will now be made to the drawings in which examples embodying the present invention are shown. Repeat use of reference characters in the present specification and drawings is intended to represent same or analogous features or elements of the invention.

The drawings and the following detailed description provide a full and detailed description of the invention and the manner and process of making and using it, so as to enable one skilled in the pertinent art to make and use it. The drawings and detailed description also provide the best mode of carrying out the invention and are not meant as limitations of the invention. The present invention thus includes modifications and variations of the following examples as come within the scope of the amended claims and their equivalents.

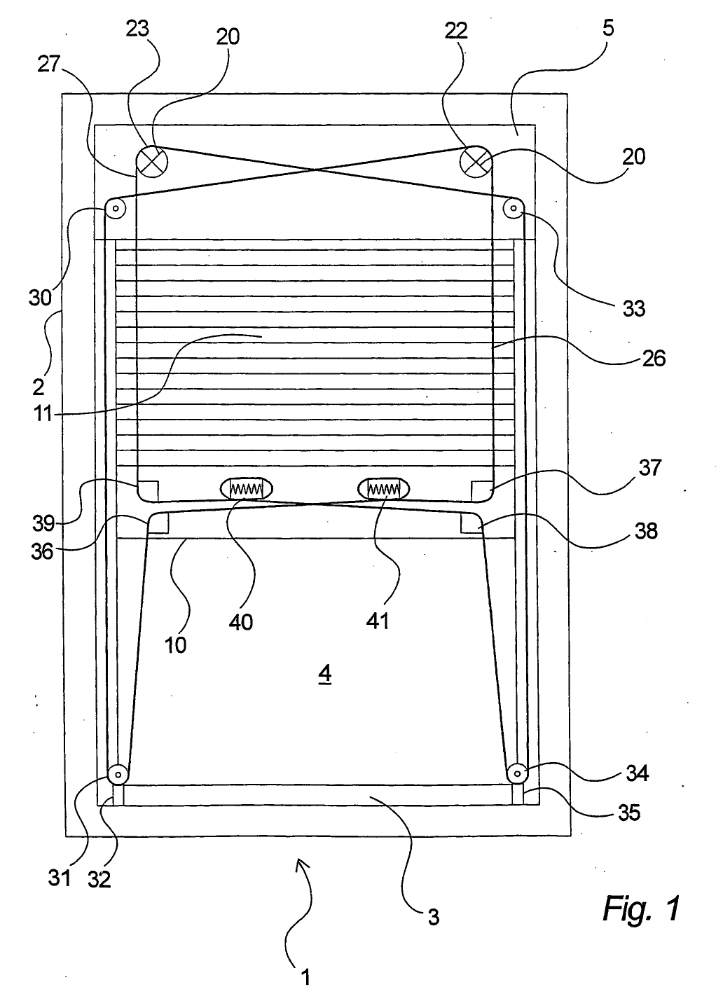

FIG. 1 shows a window, indicated in general by the reference numeral 1, seen from the inside, in which the window 1 is provided with a light-screening device, which is configured using an embodiment of the invention.

In a commonly known manner, the window 1 comprises a frame 2, which supports a sash 3. This sash 3 contains a window pane 4, and if the window is of the type which can be opened, the frame 2 and the sash 3 will also have means for use in the opening, such as hinges and handle.

Mounted on or in the sash 3 at the tope of the window 1, there is a top box 5, which out of regard for clarity in FIG. 1 is shown on an over-dimensioned scale. In practice, the top box 5 will have transverse dimensions, which are substantially comparable with or smaller than the transverse dimensions of the sash 3.

A bottom bar or gripping strip 10 is connected to a screening means in the form of a screening blind or the like 11, which extends between the bottom bar 10 and the top box 5. The screening means can be configured in a wide variety of ways, such as e.g. a pleated blind or as a Venetian blind as shown in FIG. 1, but it can also be a curtain which can be rolled up on a spring-loaded element (not shown) which may be placed in the bottom bar 10 or in the top box 5, such as is known from roller blinds. Other configurations can naturally also be used in connection with the invention.

The screening means, e.g. the screening blind 11, can be configured from different materials and may have different characteristics, all depending on the concrete application, e.g. as light-shielding against the incidence of sunlight. The blind can thus be of the type which is completely transparent but it may have a light-filtering effect, and it can also be a blind with less or more screening effect, i.e. with an arbitrary degree of transparency, possibly selected in relation to specific light spectra, and it could be a blind which serves to shield completely against incoming light, i.e. a blackout curtain.

The bottom bar 10 can be moved between an upper position in the vicinity of the top-box 5 and a lower position in the vicinity of the bottom of the window 1, and the bottom bar 10 may preferably be parked in any arbitrary position between these outer points, in that the bottom bar 10 is moved by means of a driving arrangement which will be described in more detail in the following. It will thus be understood that a greater or smaller part of the window 1 can be screened to a greater or lesser degree by means of the screening means 11.

The driving arrangement comprises at least one driving motor 20, e.g. an electric motor and preferably a DC-motor, which directly or via a transmission mechanism (not shown) can drive a first driving roller 22 and a second driving roller 23.

As shown in FIG. 1, each of the driving rollers 22 and 23 can be connected directly to its driving motor 20, e.g. by each driving roller being built together with a driving motor 20. As will appear later, these driving rollers 22 and 23 and/or these driving motors 20 are arranged in such a manner that when the one driving roller is driven to rotate to the left (counter-clockwise), the other roller will be driven to rotate to the right (clockwise) and vice versa. As will be explained in more detail in the following, with the use of this driving arrangement it will not be necessary to have any synchronization of the driving rollers 22, 23, e.g. with a mechanical connection or by an electrical/electronic arrangement, in as much as the driving arrangement shown in the figure will ensure a uniform guidance of driving cords 26, 27. For other reasons and/or in certain cases, a synchronization can, however, be desirable.

The driving rollers 22 and 23 are placed together with the driving motors 20 in the top-box 5, but it will be understood that other arrangements are possible, e.g. with one or more driving motors placed outside the top-box 5. Similarly, it will be understood that diverse transmission mechanisms, guiding and driving elements etc., should such elements be necessary, can be placed in or outside the top-box.

It will also be understood that the arrangement can exclusively comprise one driving motor, e.g. a driving motor that via a transmission mechanism can transfer driving energy to each driving roller 22 and 23.

With the driving roller 22 there is associated the first driving cord 26 briefly introduced above, which, as shown, extends in a closed circuit; i.e., the cord is “endless”. With the driving roller 23 there is associated the second driving cord 27 briefly introduced above, which is similarly endless and thus extends in a closed circuit. It will be understood that the term “driving cord” shall be taken to mean any form of driving medium which can transfer traction in the longitudinal direction, and which is sufficiently flexible in the transverse direction to be able to pass over a driving roller, pulleys, wheel etc. Use can thus be made of driving cords, driving belts, wires, cables, chains or chain-like means etc. It will also be understood that the driving rollers 22 and 23 will be arranged with regard to the actual type of driving means.

As is seen in FIG. 1, the first driving cord 26 extends from the driving roller 22 over to a pulley 30 which is placed in or at the other end of the top-box 5, and from here the first driving cord 26 extends substantially parallel with the frame 2 down towards the bottom of the window 1, where the driving cord 26 passes over a pulley 31 which is supported by a schematically-shown bracket 32. From here, the first driving cord 26 extends up towards the bottom bar 10, in as much as it extends from the one end of this bottom bar 10 to its other end and from there up towards the first driving roller 22. Where it passes the bottom bar 10, the first driving cord 26 will extend past at least one arrangement for the transfer of frictional forces, so that under normal driving conditions the driving cord 26 can draw the bottom bar 10 up and down. As shown, in extending in at the one end of the bottom bar 10, the driving cord 26 can be led over a rounded edge or the like 36, after which it passes an arrangement 41 for absorption of deviations in cord length and/or for damping of cord traction, and thereafter the driving cord 26 finally passes a rounded edge or the like 37 at the other end of the bottom bar 10. The arrangement 41 for the absorption of deviations in cord length and/or for damping of cord traction can, e.g. as illustrated, comprise two end pieces over which the driving cord 26 is wound at least one turn, the end pieces being mutually spring-loaded, but it will be apparent to the expert that use can be made of other configurations.

The second driving cord 27 will extend in a corresponding manner in as much as it from the driving roller 23 extends over to a pulley or the like 33 at the other end of the top-box 5, from where it extends down to a pulley 34 which is placed by a bracket 35 at the bottom of the window 1. From here, the second driving cord 27 extends up to the bottom bar 10 where it passes the rounded edges or the like 38 and 39 and an arrangement 40 for the absorption of deviations in cord length and/or for damping of cord traction before it extends up to the second driving roller 23.

The function of this configuration will now be explained in more detail. Upon activation of the driving arrangement by operating means such as remote control devices, control devices etc., the driving motors 20 will be activated, whereby the driving rollers 22 and 23 will rotate and cause the driving cords 26 and 27 to be moved around in their paths. If, e.g., the screening element 11 is required to be moved upwards, the driving roller 22 will be rotated to the left (counter-clockwise) and the driving roller 23 will be rotated to the right (clockwise). The first driving cord 26 will be moved downwards in the vertical path, which is shown to the left in FIG. 1, while the driving cord passes over the rotating pulleys 30 and 31. The bottom bar 10 will thus be drawn upwards by the driving cord 26 due to the friction which will exist between the driving cord and one or more of the elements which the cord passes on its way through and/or via the bottom bar 10, e.g. one or both of the rounded edges 36 and 37 and/or the arrangement 41.

The second driving cord 27 will be moved in a corresponding manner, where it will be the friction between the driving cord and one or more of the means which the cord passes on its way through and/or via the bottom bar 10, e.g. one or both of the rounded edges 38 and 39 and/or the arrangement 40, which will cause the bottom bar to be drawn upwards by the second driving cord 27. As will be seen, the use of the two driving cords will ensure that the bottom bar 10 is moved by a parallel displacement, i.e. it will not move upwards or downwards in a slantwise manner, but will maintain its parallelism with the top and bottom of the window 1. It is further seen that the movements of the two driving cords 26, 27 will mutually correspond, so that as already mentioned a synchronization between the driving motors 20 will not be necessary.

It will be obvious that the total friction between driving cord and bottom bar 10, or rather the bottom bar's friction means, shall be sufficiently great for the bottom bar 10 to be moved under all normal conditions. With the invention it is also ensured that this friction is of such an extent that a manual adjustment of the position of the bottom bar 10 can be carried out, and herewith of the screening device according to the invention. If it is desired to position the screening device manually, e.g. in the event of a power supply failure, regardless of whether this is caused by mains failure, lack of battery current etc., if a remote control is not immediately at hand or if for other reasons it is necessary or more convenient to effect manual adjustment, this can be done by gripping around the bottom bar 10 or a handle (not shown) on the bar and leading the bottom bar up or down to the desired position. This is made possible because the total friction or rather static friction between driving cords 26, 17 and the bottom bar 10 is of such a maximum amount that it can be overcome by a suitable operating push or pull, whereby the driving cords 26, 27 will slide over the rounded edges 36, 37, 38 and 39 and over the arrangements 40 and 41, while the bottom bar 10 is moved up or down. It will be understood that the friction between the driving rollers 22 and 23 and the respective driving cords 26 and 27 will normally be of such an amount that the driving force is transferred to the driving cords 26, 27 in any operative situation, and thus also higher than the total friction between driving cords 26, 27 and the bottom bar 10. Therefore, with this embodiment of the invention it can also be such that in the event of the bottom bar 10 abutting against obstacles during operation, the driving cords 26, 27 will continue to be moved but will slide over the respective guide means in/at the bottom bar 10.

It is obvious that the rounded edges 36, 37, 38 and 39 as well as the arrangements 40 and 41 can serve to produce the friction that exits in the bottom bar 10 and is applied to the driving cords 26, 27, but it is also possible to configure the arrangements 40 and 41 in such a manner that the friction arising from the arrangements will be immaterial or of a known lesser amount in relation the friction arising from the rounded edges 36, 37, 38 and 39, so that determination of the friction in the bottom bar 10 will in essence be able to be effected by configuration and/or adjustment of these rounded edges 36, 37, 38 and 39.

Moreover, according to the invention, use will be able to be made of means other than the shown rounded edges to serve as friction-determining means in or at the bottom bar 10. Use can thus be made of pulleys or wheels over which the driving cords are moved, but where these wheels are provided with braking arrangements, e.g. spring-loaded, where the braking arrangements can also be adjustable so that the correct friction can be set, e.g. at production of the arrangement. Moreover, configurations with grooves can be envisaged, where the grooves are configured with such dimensions, cross-sectional shapes and/or curvature radii that the desired friction is achieved.

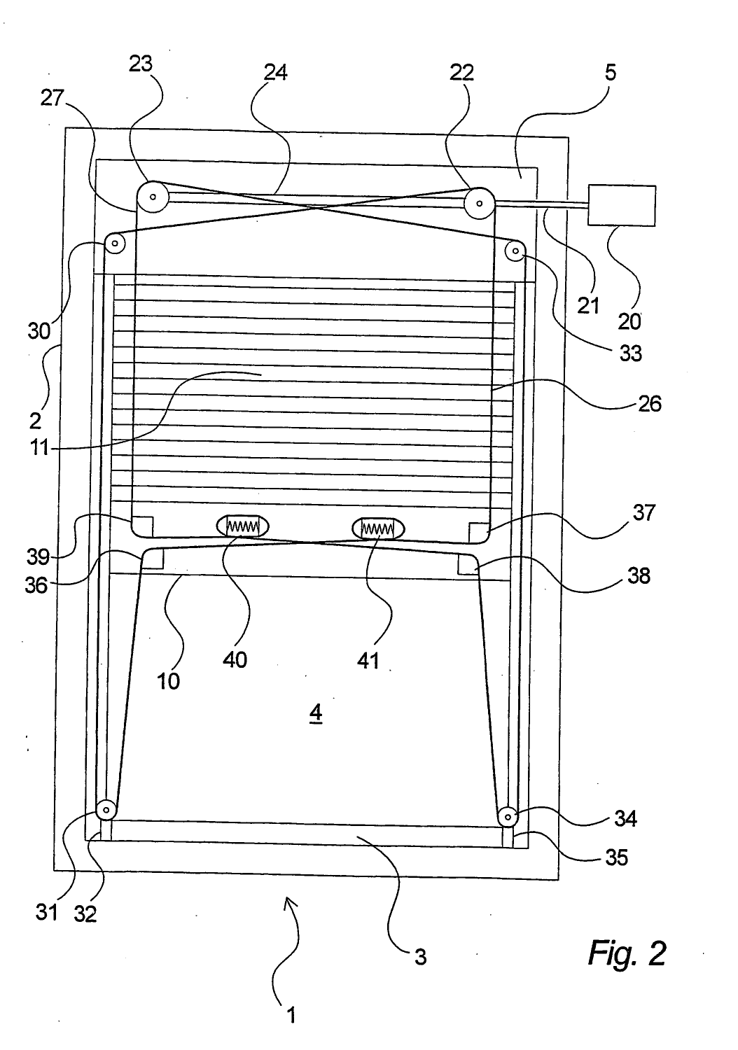

A further embodiment of the invention, which is a modification of that described above, is shown in FIG. 2, which is a schematic illustration, shows a window 1 or a similar opening in a building seen from the front, and where as described above there is placed a screening device comprising top-box 5, a movable bottom bar 10, between which a screening element 11 is arranged. Elements, which correspond to elements shown and described in connection with FIG. 1, are provided with the same reference numbers as those used above, and will not be discussed further in connection with FIG. 2.

The embodiment shown in FIG. 2 differs from that described earlier in that use is made of a single driving motor 20 which, via a schematically-shown transmission mechanism 21, can drive the first driving roller 22 and the second driving roller 23, in as much as these can be coupled together as shown at 24. Corresponding to what has been described above, the driving rollers 22 and 23 are coupled or otherwise arranged in such a manner that when the one is driven to the left, the other will be driven to the right and vice versa. It will be understood that although the driving motor 20 is shown placed at the side of the window 1, this could equally well be placed somewhere else, in or outside the top-box 5, possibly together with various transmission mechanisms, control and driving elements etc. It will also be understood that the arrangement can comprise more than one driving motor, e.g. a driving motor connected to each driving roller 22 and 23 via each its transmission mechanism.

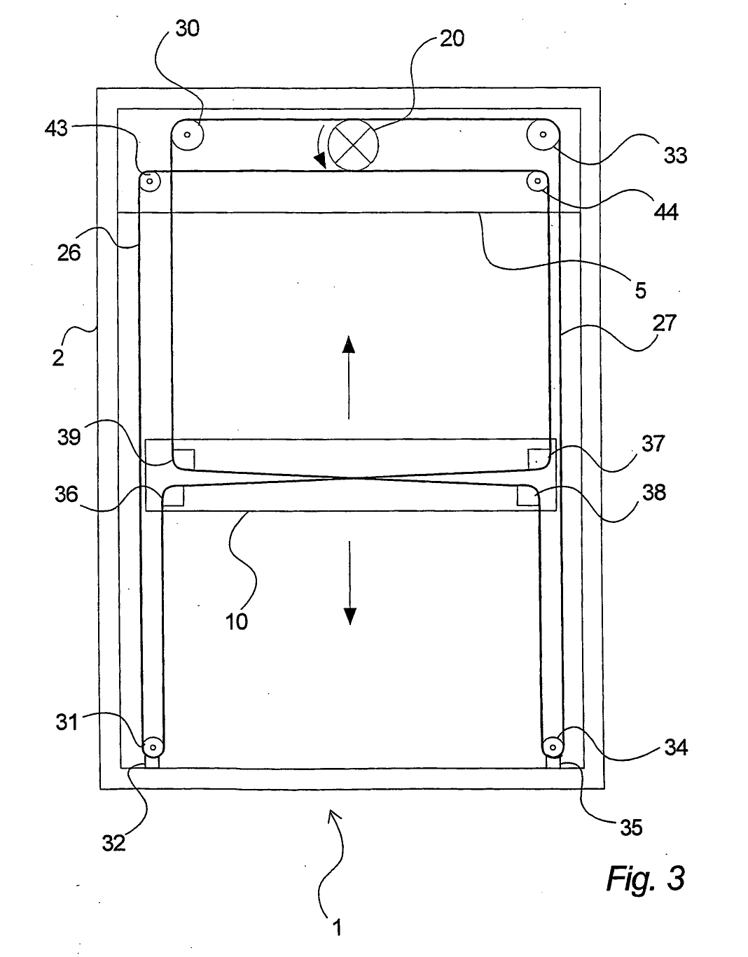

A further embodiment of the invention, which is a further modification of that described above, is shown in FIG. 3, which correspondingly shows a window 1 or a similar opening in a building seen from the front, and with a screening device comprising a top-box 5, a movable bar 10, between which there is arranged a screening element which out of regard for clarity is not shown in this figure. Elements, which correspond to elements, which are shown and described in connection with FIGS. 1 and 2, are provided with the same reference numbers as those used above and will not be discussed further in connection with FIG. 3.

The embodiment shown in FIG. 3, where use is made of only a single driving motor 20, differs from those described earlier by the connection between driving motor 20 and driving cords 26 and 27 and possibly the positioning and configuration of driving motor and a possible transmission mechanism. As shown in FIG. 3, the schematically-shown driving motor 20 and possibly a transmission mechanism are placed in the top-box 5 in such a manner that a driving wheel or the like can move both driving cords 26 and 27 simultaneously, possibly by these driving cords being disposed with one or more windings around the driving wheel of the driving motor 20, or configured in traction-transferring connection in another manner. When the driving motor rotates, the two driving cords 26, 27 at the driving motor 20 will be moved in each their direction, so that the arrangement will function as described in connection with FIG. 1 and whereby the bottom bar 10 will be moved up or down.

However, it is obvious that with this embodiment use can also be made of two (or more) driving motors, possibly with associated transmission mechanism and possibly with a mechanical or electrical/electronic synchronization which, however, as explained earlier, will not be necessary with the cord driving arrangement used.

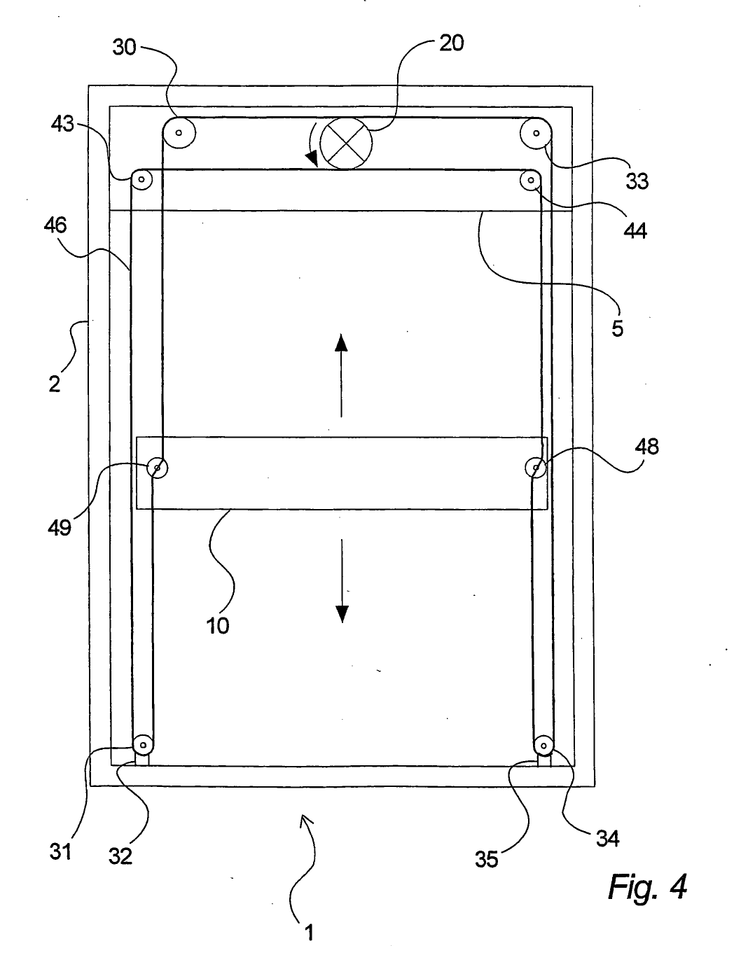

In FIG. 4 is shown a further embodiment of the invention, which corresponds in general to that shown in FIG. 3, but where use is made of only a single driving cord 46, which on the other hand does not cross itself in through or via the bottom bar 10. In the same way as in FIG. 3, FIG. 4 shows a schematic illustration of a window 1 or a similar opening in a building seen from the front, in which there is placed a screening device comprising a top-box 5 and a movable bottom bar 10, between which there is arranged a screening member, which out of regard for clarity is not shown in this figure. Elements, which correspond to elements that are shown and described in connection with FIGS. 1-3, are provided with the same reference numbers as those used above and will not be discussed further in connection with FIG. 4.

The driving cord 46 is arranged in such a manner that two cords extend in two paths through or at the top-box 5, both of these cords extending substantially from the one end to the other end of the top-box 5, and where traction-transferring connection is established to a single driving motor 20 (or more, e.g. two driving motors), and such that the one cord path will be moved the one way when the other cord path is moved the other way and vice versa.

The upper cord path extends over a pulley 30 and in a substantially vertical manner downwards towards the bottom bar 10, where the driving cord 46 is connected to a friction element 49, the function of which will be described later. From here, the driving cord 46 leads down to a pulley 31, which by way of a bracket 32 or in a corresponding manner, is placed at or in the vicinity of the bottom of the window 1. The driving cord 46 then extends substantially upwards again along the vertical window frame to a pulley 43 in or at the top-box 5, from where the driving cord 46 extends in one of the two cord paths mentioned above via the driving motor 20 over to a corresponding pulley 44 at the other end of the top-box 5. From here, the driving cord 46 extends vertically downwards to the bottom bar 10, where it is connected to a friction element 48 corresponding to friction element 49. From the bottom bar 10 the driving cord leads down to a pulley 34 which, e.g., is mounted by way of a bracket 35, and from here again substantially vertical along the window frame to a pulley 33 in the top-box 5, from where the driving cord 46 is led over to the driving motor 20 in the uppermost cord path.

It will be understood that when the driving motor 20 is activated and the two cord paths extending in or at the top-box 5 are moved in each their direction, the bottom bar 10 will be moved up or down, depending on the direction of rotation of the driving motor 20, in that the two (or more) friction elements 48 and 49 will generate a friction or rather apply static friction to the driving cord 46, this friction being sufficiently great to ensure that under normal conditions the bottom bar 10 will be moved up or down together with the respective path of the driving cord 46.

According to the invention, the friction elements 48 and 49 are both configured so that the friction or rather the static friction exercised on the driving cord 46 is not greater than it can be overcome by a suitable influence on the bottom bar 10, so that the bottom bar 10 can be moved manually up or down in the same way as described earlier. When the bottom bar 10 is moved manually up or down in this manner, the driving cord 46 will slide over, through or via the friction elements 48 and 49, depending on the configuration of these elements.

In FIG. 4 the friction elements 48 and 49 are shown in a schematic embodiment, but it will be understood that these elements can be configured as grooves or the like through which the driving cord 46 can pass, and where the driving cord 46 is led over one or more edges at inlet and/or outlet, so that these edges produce the necessary friction. Instead or additionally, the friction can be produced by the clamping of a groove around the driving cord 46. It will be apparent to an expert that it is possible for these friction elements to be configured in other ways, e.g. comprising spring-loaded mechanisms, pulleys or the like which are influenced by a brake or the like. It will also be apparent that use can be made of more than two such elements in the bottom bar 10 for producing the necessary friction.

Furthermore, it will be obvious that in connection with the embodiment shown in FIG. 4, use can be made of two driving systems, each with its separate motor, so that each driving motor transfers traction force to each its cord path and/or each its cord loop.

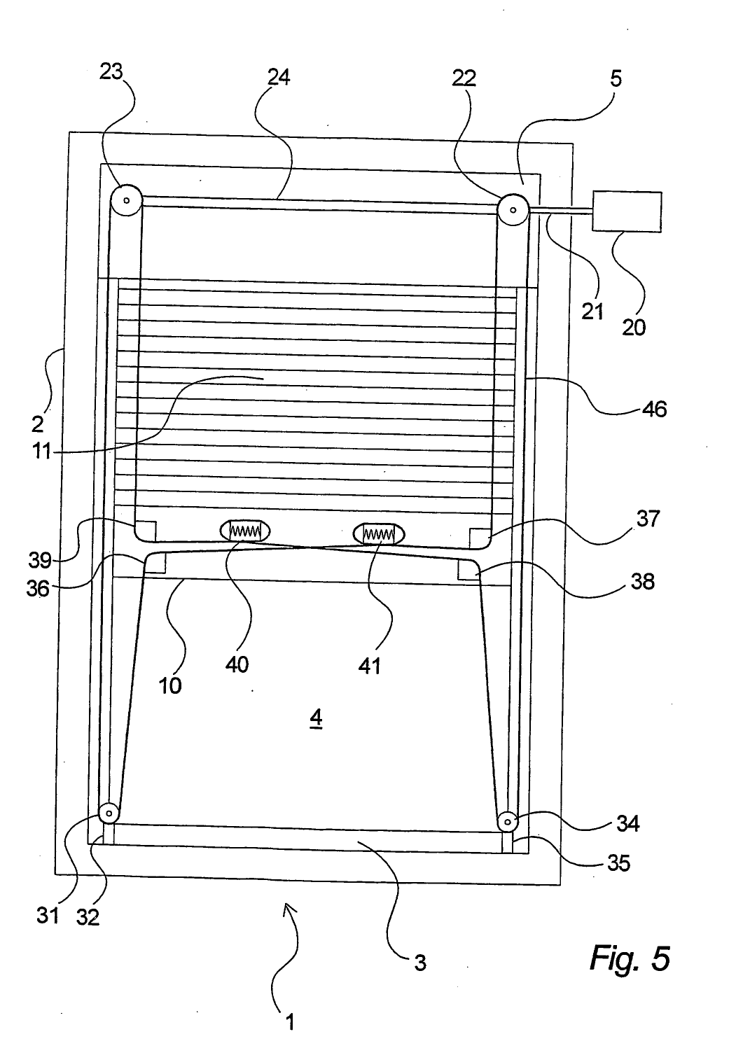

FIG. 5 shows yet another embodiment of the invention, where use is made of a single driving cord 46. As will be seen from the figure, this embodiment is provided with a single driving motor 20, which, via the transmission mechanism 21, drives two driving rollers 22 and 23, which are connected by a coupling 24. As shown, the driving cord 46 is arranged so that it leads up from the lower pulley 34 on the right-hand side to the driving roller 22, and from here down to the right-hand end of the bottom bar, where it passes the friction-producing edge 37. Hereafter, the driving cord passes through the bottom bar 10 as described earlier towards the left-hand end and down towards the lower pulley 31. From here, the driving cord leads up to the driving roller 23 at the left-hand end of the top-box, from where it is led back towards the left-hand end of the bottom bar. Here, the cord passes the friction-producing edge 39 and extends through the bottom bar as described earlier towards the right-hand end and down towards the lower pulley 34, and the loop is thus concluded.

It will be understood that with this embodiment the bottom bar 10 will be moved upwards when the driving roller 22 rotates to the right (clockwise) and the driving roller 23 rotates to the left (counter-clockwise), and correspondingly that the bottom bar 10 will be moved downwards when the driving roller 22 rotates to the left and the driving roller 23 rotates to the right. It will thus be understood that the object of the coupling 24 in the configuration shown in FIG. 5 is, among other things, to ensure that the two driving rollers are driving in each their direction. However, it will also be understood that use can be made of two driving motors, i.e. one for each driving roller. Further, it will be understood that use can be made of a driving arrangement where both driving rollers are driven the same way around if the two cords are made to cross each other in connection with one of the driving rollers 22 or 23.

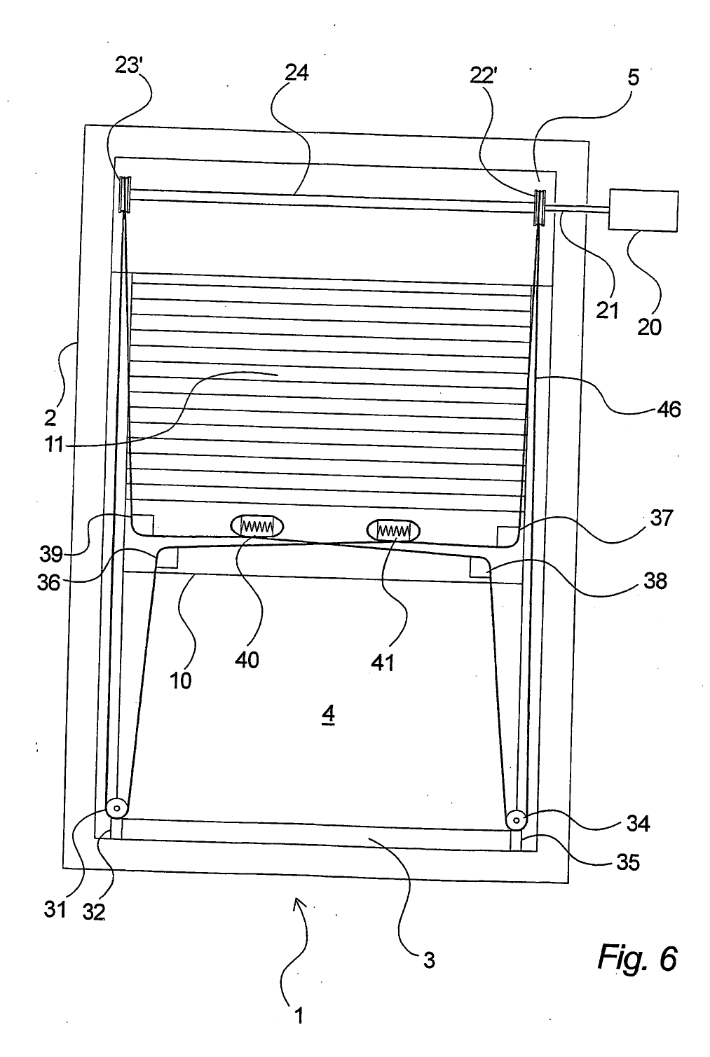

In FIG. 6 is shown an embodiment which corresponds substantially to that described in connection with FIG. 5, but where a particularly expedient configuration of the driving mechanism itself is illustrated, said driving mechanism comprising a driving motor 20, transmission mechanism 21, driving rollers and coupling 24. As will be seen, the driving rollers which in this positioning are designated 22′ and 23′ are disposed with their axes of rotation extending parallel with or in the plane of the figure, and expediently as shown lying coincident with the axis of rotation of the coupling 24, which can hereby merely be a connecting spindle. When the driving cord at both driving rollers 22′ and 23′ are moved in the same way, e.g. by the cords extending from the bottom bar up to the driving rollers at both sides being moved on the upwardly-facing or foremost side of the driving rollers (in the shown configuration), the bottom bar will immediately be moved up or down when the driving rollers rotate in the same direction simultaneously. By making use of a spindle or the like as coupling 24, a synchronization will also be directly achieved, so that the bottom bar is moved up and down in a parallel movement.

It will be apparent to the skilled artisan that pulleys, driving rollers etc., can be disposed in ways other than those shown in the figures, which illustrate the principles of the invention. It will also be appreciated that axes of rotation for driving rollers, pulleys etc., can be arranged in other ways than shown, where the axes of rotation are shown lying in the plane of the figures or at right angles hereto. Other angles can naturally be envisaged, e.g. out of regard for practical conditions.

In connection with the embodiments shown in FIGS. 1 to 6, with all embodiments it is illustrated that the driving elements for the driving cord or the driving cords 26, 27, 46 are positioned in connection with the top-box 5, but it will be understood that other positions naturally are possible in connection with the invention. A driving motor 20 can thus be positioned so that traction can be transferred to a driving roller or the like at any place along a path for a driving cord. In particular it can be mentioned that any of the pulleys, rollers, cord-wheels or the like which are shown in the foregoing figures can be arranged as a driving element. It will thus also be possible that a driving motor with associated driving roller or the like can be placed at or in the vicinity of e.g. the bottom of a window opening. If use is made of two driving motors, these can, e.g., both be placed together with associated driving wheels or driving rollers at the bottom of a window opening, or one can be placed in the top, e.g. in the top-box 5, while the other can be placed at the bottom.

Moreover, it will be appreciated that although use is made in the above of the terms “top-box” and “bottom bar”, a top-box or an element or group of elements with corresponding functions can be placed in any position in connection with an opening in a building, e.g. also at a bottom or at an end of an opening in a building. It will be further appreciated that a movable element, e.g. in the form of a bottom bar, can be moved in any manner which is suitable for the actual construction. It will also be apparent that the screening element can be gathered together at the top-box in the inactive position, but that it can just as well be gathered together, e.g. at the bottom bar if it is a roller blind where this can be rolled up in the top-box or can be rolled up in the bottom bar.

In connection with known automated and/or motorized arrangements for operation of screening devices, it is often normal that the motor drive is stopped automatically in an end position and/or at an obstacle, in as much that in certain cases there will occur a deviation in motor current, i.e. a motor current which exceeds a pre-defined amount.

The use of such a system for automatic stopping will be problematic in connection with the invention, the reason being, as will be understood, that when a screening device according to the invention reaches an end position, i.e. e.g. when the bottom bar reaches down to the bottom of the window frame or up to the top-box or the top of the window frame, the driving motor or the driving motors will be able to continue to move the driving cord 46 or the driving cords 26 and 27, in that these will be able to slide over, through or via the friction connections 48 and 49 or the friction-producing means 36-39. It will, of course, hereby be possible to detect a deviating motor current, i.e. a slightly increased motor current, but since it is necessary for a certain tolerance to be built into such a system to avoid erroneous de-couplings, this will not necessarily be sufficient to be able to stop the operation of the motor.

According to a further embodiment of the invention, the possibility of being able to use a system for stopping the screening device has thus been taken into account, the operation of the system following a principle which in itself is commonly known, where detection of motor current or corresponding parameters can be used as or constitute input parameter(s).

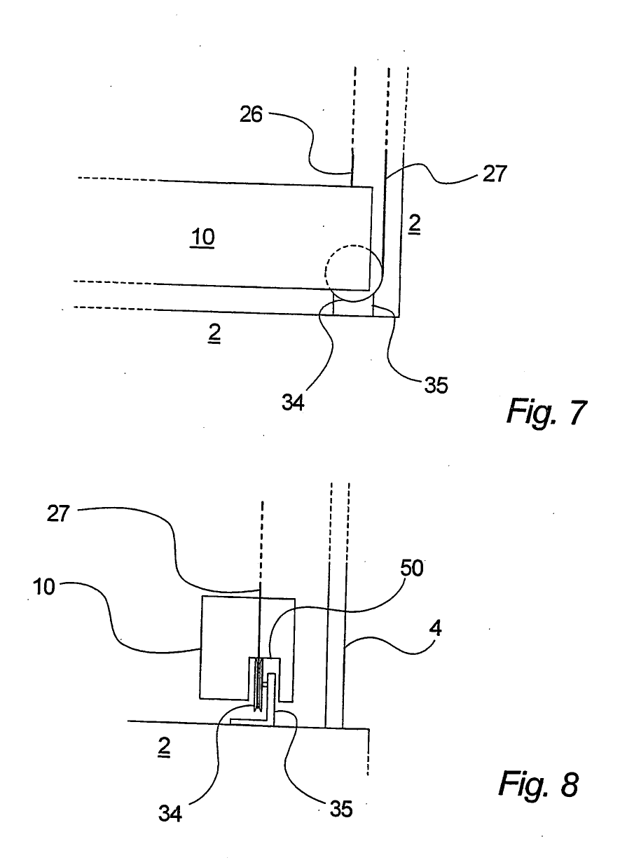

An example of such an embodiment is shown in FIGS. 7 and 8, which in an enlarged illustration show a detail section of an end of a bottom bar 10 in the vicinity of the bottom of a window frame 2 seen from the front and from the end of the bottom bar 10 respectively.

In FIG. 7 is thus seen a part of the bottom bar 10 in the vicinity of the frame 2, and there is thus also shown a part of a driving cord 27, which extends down around a pulley 34 which, e.g., can be mounted in the window 1 by means of a bracket 35. As described above in connection with FIGS. 1, 2, 3, 5 and 6, the driving cord can extend from the pulley 34 and via the bottom bar 10 over to the opposite end of the bottom bar 10 via (not shown) friction-producing elements, and correspondingly the other driving cord 26 can extend from the other end of the bottom bar 10 to the shown end, and as shown in FIG. 7 from here further up towards the top-box 5.

According to this embodiment, the bottom bar 10 and the pulley 34 will make contact with each other when the bottom bar 10 reaches down to a lowermost position, which e.g. can occur as shown in FIG. 8, where it is seen that the bottom bar 10 is configured with a recess or the like 50 in which the pulley 34 and possibly parts of the bracket 35 can wholly or partly be accommodated. As shown, the pulley 34 can touch a surface or surfaces in this recess 50 over a greater or smaller part of its surface, which will have an effect such as described in more detail in the following.

When the screening device according to the invention has brought the bottom bar 10 into a lowermost position where it can no longer move, e.g. because the bottom bar 10 abuts against the bottom of the frame 2, the driving motor 20 or driving motors will continue to run, while the driving cord or cords 26, 27, 46 will slide over, through or via the friction-producing elements, e.g. 36-39 or 48 and 49, which as described above will not necessarily give rise to any distinct change in motor current. With the arrangement shown in FIG. 7 and 8, the bottom bar 10 and the pulley 34 will, however, come into friction-producing connection which will partly brake the pulley or possibly brake it completely, so that the power which is necessary for the movement of the driving cord or cords 26, 27, 46 will be increased to such a degree that a distinct change in motor current or a corresponding parameter can be detected. A control system will hereby safely be able to detect an end position and will thus be able to bring the driving motor 20 or motors to a standstill.

It will be appreciated to those skilled in the art that a similar arrangement can be provided in connection with an upper end position, e.g. by a pulley 33 as shown in FIG. 1 being arranged in such a manner that it makes contact with a part of the bottom bar 10 when this is in an upper position, so that the pulley is braked and the traction force is increased to a distinct degree.

Similarly, it will be appreciated that such arrangements can be provided at both sides of the screening device, or only at a single side. Similarly any of the pulleys or similar means for moving the driving cord or cords can be used in this connection to increase the friction and hereby the traction force exercised in an end position for the screening device.

Moreover, it shall be noted that the manner in which the bottom bar and one or more pulleys come into contact with one another can be configured in many different ways, as will be exemplified in the following.

The bottom bar 10 in general can abut against a pulley, e.g. the pulley 34, or as shown in FIG. 8 use can be made of a bottom bar with a special configuration in the relevant area. A recess 50 can have a curved surface, which will correspond to a part of the periphery of the pulley, and additionally or instead the recess can have an upwardly tapering shape, so that it will clamp around the sides of the pulley. Additionally or instead, the pulley can be configured with a surface, e.g. at its periphery, which is formed to reinforce a braking effect, e.g. with a rough surface, a surface provided with projection or the like. Similarly, surfaces in the recess 50 or the bottom bar can have similar friction-producing means.

Moreover, it shall be noted that a pulley can be provided with teeth or the like or simply connected to a gear wheel, e.g. placed at the side of the pulley, and that the bottom bar can be configured with an element such as a pointed part, a plate part, a tooth or the like, which will enter into engagement with the teeth on or at the pulley when the bottom bar is in the end position, so that the pulley is effectively braked in this position.

In the foregoing, the invention is described in connection with a concrete example, where a screening device is configured in such a manner that it can be used in connection with a window, but the device can also be used in connection with other openings existing in buildings such as doors or the like.

Furthermore, the driving arrangement according to the invention can be used in other connections, where, e.g., it can drive other elements such as light-screens on transparent roof surfaces, in connection with greenhouses etc., and on the whole where use shall be made of a driving arrangement with parallel guiding arrangement.

As mentioned earlier, it can be envisaged that the driving arrangement can also be used to drive elements other than cloth-like materials. E.g., in connection with windows and doors the elements can be in the form of Venetian blinds, which are drawn up and down by means of the driving arrangement. Further, it can be in the form of folding or pleated blinds, curtains that are gathered together by being “folded-up”, insect screens and the like.

It shall also be noted that the elements mentioned such as driving cords, driving rollers, pulleys, pivots, edges, slots etc., can be configured in a wide variety of ways, which will be apparent to the skilled person, and that the elements are to be understood to be any element which can exercise a friction corresponding to that of the specifically-mentioned element. It will thus be appreciated that when a driving wheel is mentioned, it will be possible to use any corresponding element, which can drive or draw a driving cord or a corresponding driving medium in connection with the invention.

1. A screening device for screening an opening in a structure, the screening device comprising.
a screening material configured for storage in an inactive position defined at a first position of the structure,
a movable part connected to a free end of the screening material,
at least one endless driving cord, the movable part movable in relation to the first position by the at least one endless driving cord,
at least one a driving motor, the at least one endless driving cord driven by the at least one driving motor, and
means for producing friction, the movable part mechanically connected to the at least one endless driving cord by the means for producing friction.

2. The screening device according to claim 1, wherein the means for producing friction includes at least one edge over which the at least one driving cord is guided.

3. The screening device according to claim 1, wherein the means for producing friction includes at least two edges over which the at least one driving cord is guided.

4. The screening device according to claim 3, wherein the edges are rounded to provide a predetermined length of a contact surface.

5. The screening device according to claim 1, the means for producing friction includes guiding means for guiding the at least one driving cord.

6. The screening device according to claim 1, wherein the means for producing friction includes a clamp, the clamp configured to be spring-loaded, adjustable, or combinations thereof.

7. (canceled)

8. The screening device according to claim 1, wherein the at least one driving cord is guided in a closed path by a pulley the means for producing friction-disposed in or proximate the movable part in communication with the at least one driving cord.

9. The screening device according to claim 1, further comprising a control circuit configured for stopping the device at a plurality of predetermined positions, including the first position of the structure and positions spaced apart from the first position.

10. The screening device according to claim 9, wherein the device is configured that at each of the predetermined positions, the movable part, engages with means, for guiding the driving cord when the movable part, is moved.

11. The screening device according to claim 10, further comprising means for effecting a braking of the means for guiding.

12. The screening device according to claim 10, wherein the movable part defines a recess for reception of the means for guiding.

13-14. (canceled)

15. The screening device according to claim 1, wherein the screening material is rolled-up, folded or gathered in the inactive position and wherein the screening material is one of a roller blind, a foldable curtain, a Venetian blind or a shutter arrangement.

16. The screening device according to claim 1, wherein the structure is a building, a window, or a door.

17. The screening device according to claim 5, wherein the guiding means for guiding define a groove for guiding the driving cord.

18. The screening device according to claim 8, further comprising at least one other driving cord, wherein the driving cords cross each other in or proximate the movable part.

19. The screening device according to claim 9, further comprising a transmission mechanism in communication with the driving motor and at least one driving roller configured for driving the driving cord.

20. A screening device for screening an opening in a structure, the screening device comprising:
a screening material configured for compressed storage at an inactive position of a structure opening and for expansion to screen the structure opening;
a movable part connected to a free end of the screening material;
an endless driving cord movably connected about a portion of the structure opening, the portion configured to redirect a movement of the endless driving cord;
a motor configured to drive the endless driving cord about the portion of the structure opening, the movable part movable in relation to the inactive position as the endless driving cord moves about the portion of the structure; and
a friction producing device configured to control a rate of the movement of the endless driving cord about a portion of the structure opening, the movable part connected to the at least one endless driving cord by the friction producing device.

21. The screening device according to claim 20, wherein the screening material is one of a roller blind, a foldable curtain, a Venetian blind or a shutter arrangement, the screening material configured to be rolled-up, folded or gathered in the inactive position and further configured to screen against natural elements, light, and insects when expanded to screen the structure opening.

22. The screening device according to claim 20, further comprising an adjustment device arranged within the structure opening, the adjustment device configured to further control the movement of the endless driving cord.

23. The screening device according to claim 22, wherein the adjustment device is configured to dampen the movement of the endless driving cord.

24. The screening device according to claim 22, wherein the adjustment device is configured to control a length of the endless driving cord.
